(19) United States
(12) Patent Application Publication
(10) Pub. No.: US 2023/0381890 A1
(43) Pub. Date: Nov. 30, 2023

(54) LASER PROCESSING SYSTEM AND CONTROL METHOD

(71) Applicant: FANUC CORPORATION, Yamanashi (JP)

(72) Inventor: Atsushi MORI, Yamanashi (JP)

(73) Assignee: FANUC CORPORATION, Yamanashi (JP)

(21) Appl. No.: 18/247,625

(22) PCT Filed: Oct. 14, 2021
(86) PCT No.: PCT/JP2021/038030

§ 371 Date: Mar. 31, 2023

(30) Foreign Application Priority Data
Oct. 16, 2020 (JP) 2020-174437

(51) Int. Cl. B23K 26/082; B23K 26/08

(52) U.S. Cl. CPC B23K 26/082; B23K 26/0876

(57) ABSTRACT

Provided is a laser processing system with which correction of a control point can be carried out easily. This laser processing system is provided with a scanner capable of scanning a workpiece with laser light, a moving device for moving the scanner relative to the workpiece, and a scanner control device for controlling the scanner, wherein the scanner control device has an irradiation control unit for controlling the scanner such that the same preset control point on the workpiece is irradiated with the laser light when the scanner has been stopped at a plurality of positions by the moving device.

### TECHNICAL FIELD

The present invention relates to a laser processing system and a control method thereof.

### BACKGROUND ART

Conventionally, a laser processing system has been proposed in which a workpiece is irradiated with a laser beam from a position away from the workpiece to perform welding. In the laser processing system, a scanner that emits a laser beam is provided at the tip of an arm of a robot. The axes of the robot of the laser processing system are driven in accordance with a program stored in advance in a control device similarly to other industrial robots. Therefore, teaching work for creating a program using an actual machine and a workpiece is performed at a work site (for example, see Patent Document 1).
Patent Document 1: Japanese Unexamined Patent Application, Publication No. 2012-135781

### DISCLOSURE OF THE INVENTION

### Problems to be Solved by the Invention

When laser processing is performed using such a laser processing system, a deviation between the path of a laser irradiation point in the program and the actual path of the laser irradiation point becomes an issue.

Since the path of the laser irradiation point can be considered to be represented by a sequence of points in a coordinate system with respect to the base of the robot in a workspace, these points are referred to as control points. The control point may be a point on the path of the laser irradiation point, or may be a point that is not on the path of the laser irradiation point but is necessary to define the path of the laser irradiation point, such as the center of an arc. The control point requires a direction defining a machining shape with respect to the control point, i.e., a coordinate system.

A robot program and a scanner program are generated according to the position of each control point and each point of the direction (coordinate system of the control points) set in the program generation device of the laser processing system. However, a CAD data and the actual workpiece do not coincide with each other, and there are positional errors in the operation path of the robot, jigs, and the like. Therefore, it is necessary to teach and correct such a deviation and errors.

In addition, when combining a robot with a scanner in a laser processing system, a tool-center point (TCP) may need to be corrected. The TCP is represented by a position vector from the robot tip point to the scanner reference point. By correctly setting the TCP, the laser irradiation position on the program coincides with the actual laser irradiation position regardless of the posture of the robot.

Conventionally, correction of the control point and setting of the TCP have been performed using a teaching jig indicating a specific point immediately below the scanner. Usually, the specific point is the origin of the workspace of the scanner, and is set to a point where the laser is focused.

To indicate the specific point, a teaching jig made of metal, resin, or the like is used, or a plurality of additional guide lasers are crossed and the intersection is visually recognized. In either method, since the coordinates of one point immediately below the scanner are acquired, it is necessary to operate the robot to match a desired position on the actual workpiece with the specific point, which is not efficient.

In addition, in the conventional method, it is necessary to attach a teaching jig to the robot and to install an additional guide laser on the scanner. Therefore, a laser processing system capable of easily correcting a control point without requiring a teaching jig, an additional guide laser, or the like has been awaited.

### Means for Solving the Problems

A laser processing system according to the present disclosure includes a scanner capable of scanning a workpiece with a laser beam, a moving device configured to move the scanner relative to the workpiece, and a scanner control device configured to control the scanner. The scanner control device includes an irradiation control unit configured to control the scanner to irradiate a preset identical control point on the workpiece with the laser beam in a state in which the scanner is stopped at a plurality of positions by the moving device.

A method for controlling a laser processing system according to the present disclosure includes: moving a scanner capable of scanning a workpiece with a laser beam, relative to the workpiece; stopping a moving device for moving the scanner relative to the workpiece at a plurality of positions; and controlling the scanner to irradiate a preset identical control point on the workpiece with the laser beam in a state in which the scanner is stopped at the plurality of positions by the moving device.

### Effects of the Invention

According to the present invention, it is possible to easily correct a control point.

### BRIEF DESCRIPTION OF THE DRAWINGS

FIG. 1 shows the overall configuration of a laser processing system according to the present embodiment;

FIG. 2 is a diagram for illustrating the optical system of a scanner in the laser processing system according to the present embodiment;

FIG. 3 is a block diagram showing the functional configuration of the laser processing system according to the present embodiment;

FIG. 4 is a block diagram showing the functional configuration of a scanner control device according to the present embodiment;

FIG. 5 shows an example of a laser irradiation shape;

FIG. 6A shows the operation of the scanner when laser processing is actually performed;

FIG. 6B shows the operation of the scanner when a control point is corrected;

FIG. 7A shows an operation of correcting the control point;

FIG. 7B shows an operation of correcting the control point;

FIG. 7C shows an operation of correcting the control point;

FIG. 7D shows an operation of correcting the control point;

FIG. 7E shows an operation of correcting the control point;

FIG. 8A shows an operation for calculating a corrected control point;

FIG. 8B shows an operation for calculating the corrected control point;

FIG. 8C shows an operation for calculating the corrected control point;

FIG. 8D shows an operation for calculating the corrected control point; and

FIG. 9 is a flowchart showing the flow of processing of the laser processing system according to the present embodiment.

### PREFERRED MODE FOR CARRYING OUT THE INVENTION

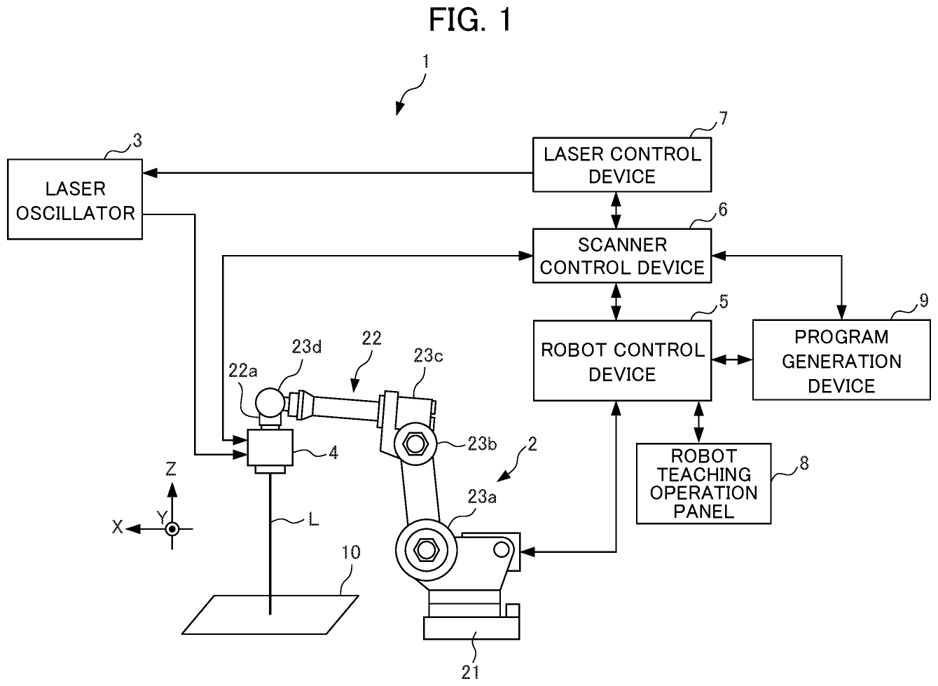

Embodiments of the present invention will now be described with reference to the drawings. FIG. 1 shows the overall configuration of a laser processing system 1 according to the present embodiment. The laser processing system 1 shown in FIG. 1 shows an example of a remote laser welding robot system.

The laser processing system 1 includes a robot 2, a laser oscillator 3, a scanner 4, a robot control device 5, a scanner control device 6, a laser control device 7, a robot teaching operation panel 8, and a program generation device 9.

The robot 2 is, for example, an articulated robot having a plurality of joints. The robot 2 includes a base 21, an arm 22, and a plurality of joint axes 23a to 23d each having a rotation axis extending in a Y direction.

Further, the robot 2 includes a plurality of robot servo motors, such as a robot servo motor that causes the arm 22 to rotationally move with a Z direction as a rotation axis, and a robot servo motor that causes the arm 22 to move in an X direction by rotating the joint axes 23a to 23d. Each of the robot servo motors rotationally drives based on drive data from the robot control device 5 described later.

The scanner 4 is fixed to a leading end portion 22a of the arm 22 of the robot 2. Accordingly, the robot 2 can move the scanner 4 to any position and orientation in a workspace at a predetermined robot speed by the rotational drive of each robot servo motor. That is, the robot 2 is a moving device that moves the scanner 4 relative to a workpiece 10. In the present embodiment, the laser processing system 1 uses the robot 2 as a moving device, but the present invention is not limited thereto. For example, a three-dimensional machining device may be used as a moving device.

The laser oscillator 3 includes a laser medium, an optical resonator, and an excitation source. The laser oscillator 3 generates a laser beam with laser output based on a laser output command from the laser control device 7 described later, and supplies the generated laser beam to the scanner 4. Examples of the type of laser to be oscillated include a fiber laser, a CO₂ laser, and a YAG laser. The type of laser is not limited in the present embodiment.

The laser oscillator 3 can output a processing laser for machining the workpiece 10 and a guide laser for adjusting the processing laser. The guide laser is a visible laser adjusted on the same axis as the processing laser.

The scanner 4 receives a laser beam L emitted from the laser oscillator 3 and can scan the workpiece 10 with the laser beam L.

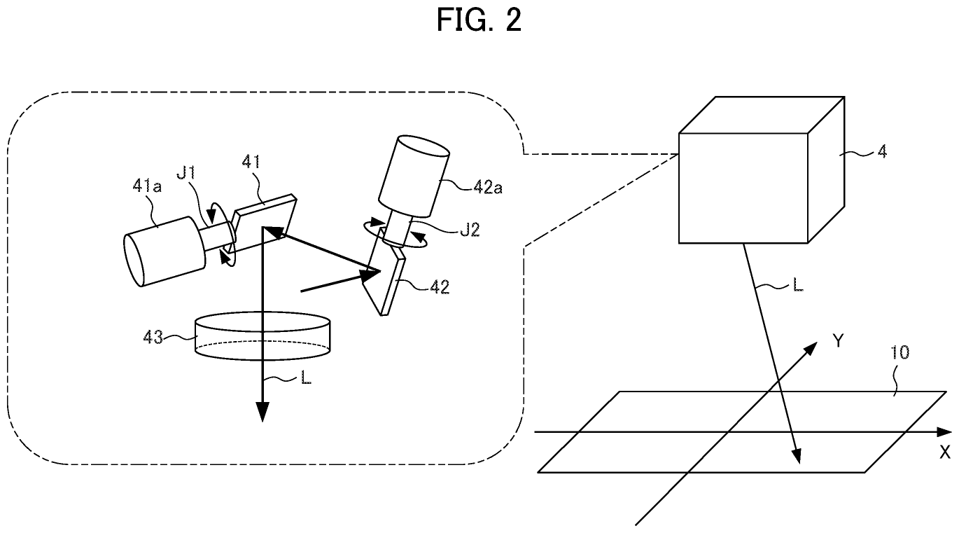

FIG. 2 is a diagram for illustrating the optical system of the scanner 4 in the laser processing system 1 according to the present embodiment. As shown in FIG. 2, the scanner 4 includes, for example, two galvano mirrors 41 and 42 that reflect the laser beam L emitted from the laser oscillator 3, galvano motors 41a and 42a that rotationally drive the galvano mirrors 41 and 42, respectively, and a cover glass 43.

The galvano mirrors 41 and 42 are configured to be respectively rotatable around two rotation axes J1 and J2 orthogonal to each other. The galvano motors 41a and 42a rotationally drive based on the drive data from the laser control device 7 to independently rotate the galvano mirrors 41 and 42 around the rotation axes J1 and J2.

The laser beam L emitted from the laser oscillator 3 is sequentially reflected by the two galvano mirrors 41 and 42, then is emitted from the scanner 4, and reaches a processing point (welding point) of the workpiece 10. At this time, when the two galvano mirrors 41 and 42 are respectively rotated by the galvano motors 41a and 42a, the incident angles of the laser beam L incident on the galvano mirrors 41 and 42 continuously change. As a result, the workpiece 10 is scanned with the laser beam L from the scanner 4 along a predetermined path, and a welding trajectory is formed on the workpiece 10 along the scanning path of the laser beam L.

The scanning path of the laser beam L emitted from the scanner 4 onto the workpiece 10 can be optionally changed in the X and Y directions by controlling the rotational drive of the galvano motors 41a and 42a as appropriate to change the rotation angles of the galvano mirrors 41 and 42.

The scanner 4 also includes a zooming optical system (not shown) capable of changing the positional relationship with a Z-axis motor. The scanner 4 can optionally change the laser irradiation point in the Z direction by moving, in an optical axis direction, the point where the laser is focused, by the drive control of the Z-axis motor.

The cover glass 43 is disk-shaped, and has a function of transmitting the laser beam L sequentially reflected by the galvano mirrors 41 and 42 toward the workpiece 10 and protecting the inside of the scanner 4.

The scanner 4 may be a trepanning head. In this case, the scanner 4 can have, for example, a configuration in which, a lens having one inclined surface is rotated by a motor to refract the incident laser and irradiate to any location.

The robot control device 5 outputs drive control data to each robot servomotor of the robot 2 to control the operation of the robot 2 in accordance with a predetermined robot program.

The scanner control device 6 adjusts the positions of the lens and mirrors in the mechanism of the scanner 4. The scanner control device 6 may be incorporated in the robot control device 5.

The laser control device 7 controls the laser oscillator 3, and controls it to output a laser beam in response to a command from the scanner control device 6. Not only may the laser control device 7 be connected to the scanner control device 6, but the laser control device 7 may also be directly connected to the robot control device 5. Alternatively, the laser control device 7 may be integrated with the scanner control device 6.

The robot teaching operation panel 8 is connected to the robot control device 5, and is used by an operator to operate the robot 2. For example, the operator inputs machining information for performing laser processing through a user interface on the robot teaching operation panel 8.

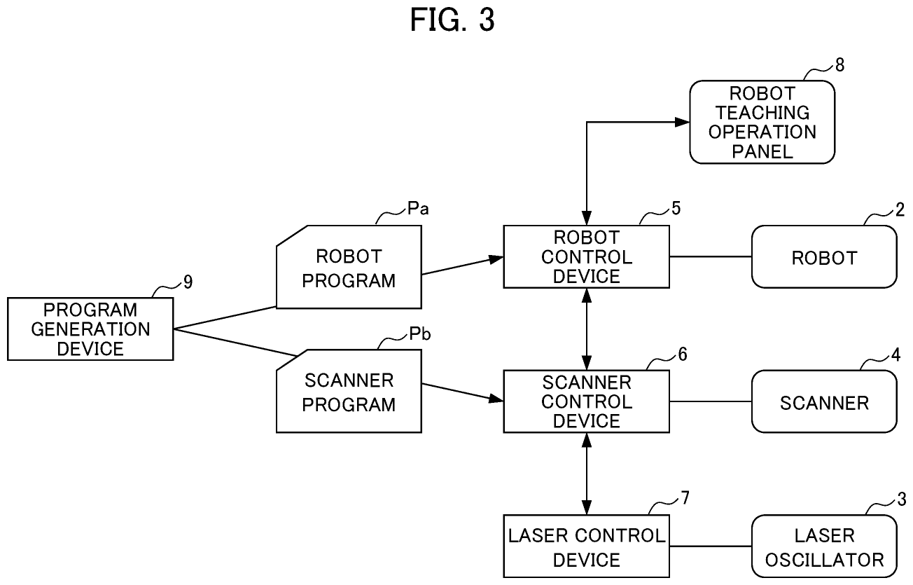

The program generation device 9 is connected to the robot control device 5 and the scanner control device 6, and generates programs for the robot 2 and the scanner 4. The program generation device 9 will be described in detail with reference to FIG. 3. In the present embodiment, it is assumed that at least the scanner 4, and preferably also the robot 2, are adjusted so as to operate accurately in response to commands of the programs.

FIG. 3 is a block diagram showing the functional configuration of the laser processing system 1 according to the present embodiment. As described above, the laser processing system 1 includes the robot 2, the laser oscillator 3, the scanner 4, the robot control device 5, the scanner control device 6, the laser control device 7, the robot teaching operation panel 8, and the program generation device 9. Hereinafter, with reference to FIG. 3, the operations of the robot control device, the scanner control device 6, the laser control device 7, and the program generation device 9 will be described in detail.

The program generation device 9 generates a robot program Pa for the robot 2 and a scanner program Pb for the scanner 4 in a virtual workspace from CAD/CAM data. Further, the program generation device 9 generates a control point correction program for correcting a control point.

The generated robot program Pa and scanner program Pb are respectively transferred to the robot control device 5 and scanner control device 6. When the robot program Pa stored in the robot control device 5 is started by operating the robot teaching operation panel 8, a command is sent from the robot control device 5 to the scanner control device 6, and the scanner program Pb is also started.

The robot control device 5 outputs a signal when the robot 2 conveys the scanner 4 to a predetermined position. In response to the signal output from the robot control device 5, the scanner control device 6 drives the optical system in the scanner 4.

The scanner control device 6 commands the laser control device 7 to output a laser. The robot control device 5, the scanner control device 6, and the laser control device 7 synchronize the movement of the robot 2, the scanning of the laser beam axis, and the output of the laser beam by exchanging signals at appropriate timings.

The robot 2 and the scanner 4 share position information and time information, and control the laser irradiation point at a desired position in the workspace. Further, the robot 2 and the scanner 4 start and end laser irradiation at appropriate timings. Thus, the laser processing system 1 can perform laser processing such as welding.

The program generation device 9 incorporates 3D modeling software. The operator can operate the models of the robot 2 and the scanner 4 on the computer to check the laser irradiation point, coordinate values, and so on.

Further, the program generation device 9 generates a 3D model of the workpiece 10 using the CAD data of the workpiece 10, and sets one or more control points on the 3D model of the workpiece 10. Then, the program generation device 9 defines a welding shape with respect to the set control points.

As described above, since the path of the laser irradiation point can be considered to be represented by a sequence of points in the coordinate system with respect to the base of the robot in the workspace, these points can be referred to as control points. The control points may be on the path of the laser irradiation point, or may be points necessary to define the path of the laser irradiation point, not on the path of the laser irradiation point, such as the center of an arc.

Once the control points and the welding shape are defined, the program generation device 9 calculates the robot path along which the robot 2 moves and the scanning path of the laser irradiation point by the scanner 4.

With respect to the laser irradiation point in the three-dimensional space, the posture of the robot 2 and the rotation angles of the galvano motors 41a and 42a at the laser irradiation point by the scanner 4 are not uniquely determined. Therefore, the program generation device 9 includes an algorithm for searching for an optimal solution that satisfies conditions. The conditions in generating the robot program Pa and the scanner program Pb include shortening machining time, limiting the laser irradiation angle with respect to the workpiece 10, and limiting the posture range of the robot 2.

When the control point is corrected by the control point correction program, the scanner control device 6 transmits the position information and the direction information of the corrected control point to the program generation device 9.

The program generation device 9 regenerates the robot program Pa and the scanner program Pb based on the position information and the direction information of the corrected control point using the above-described algorithm for searching for the optimal solution. The generated robot program Pa and scanner program Pb are transmitted to the scanner control device 6 again.

In this way, by generating the robot program Pa and the scanner program Pb reflecting the corrected control point, the program generation device 9 can correct the robot path in the robot program Pa and the irradiation path of the laser beam by the scanner 4 in the scanner program Pb.

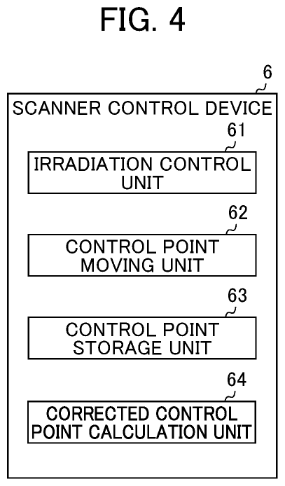

FIG. 4 is a block diagram showing the functional configuration of the scanner control device 6 according to the present embodiment. As shown in FIG. 4, the scanner control device 6 includes an irradiation control unit 61, a control point moving unit 62, a control point storage unit 63, and a corrected control point calculation unit 64.

The irradiation control unit 61 controls the scanner 4 to irradiate a preset identical control point on the workpiece 10 with a laser beam in a state in which the scanner 4 is stopped at a plurality of positions by the robot 2. If the position of the scanner 4 is different, the emitting direction of the laser beam by the scanner 4 is different. Further, the irradiation control unit 61 controls the scanner to irradiate the workpiece with the laser beam based on the position of the control point, or the position of the control point and the direction of the control point in the coordinate system stored in the control point storage unit 63.

When the control point is at a plurality of positions, the irradiation control unit 61 controls the scanner to irradiate the workpiece with the laser beam based on the plurality of positions of the control point, or the plurality of positions of the control point and directions of the control point in the coordinate system stored in the control point storage unit 63.

The plurality of positions include a laser irradiation start position and a laser irradiation end position of the scanner 4 corresponding to a laser irradiation start point and a laser irradiation end point of the scanner program for controlling the scanner 4 and the robot program for controlling the robot 2.

The control point moving unit 62 moves the control point in response to an operation of the robot teaching operation panel 8 by the operator. The control point storage unit 63 stores a plurality of positions of the moved control point, or the plurality of positions of the control point and a plurality of directions defined by the control point in the coordinate system.

The corrected control point calculation unit 64 calculates a corrected control point which is a finally corrected control point based on the plurality of positions of the control point, or the plurality of positions of the control point and the plurality of directions of the control point in the coordinate system stored in the control point storage unit 63.

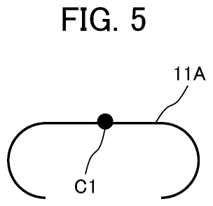

FIG. 5 shows an example of a laser irradiation shape 11A. As shown in FIG. 5, the laser irradiation shape 11A has a C shape, and is irradiated with respect to a control point C1. In the present embodiment, the laser processing system 1 performs laser processing of the laser irradiation shape 11A by the movement of the robot 2 and the scanning of the laser optical axis by the scanner 4 with respect to the control point C1.

Specifically, the program generation device 9 calculates an appropriate path of the robot 2 and an appropriate path of the scanner 4 from the positional relationship between the earlier and later irradiation shapes, generates a robot program and a scanner program to which the calculated path of the robot 2 and the calculated path of the scanner 4 are applied, and transmits the robot program and the scanner program to the robot control device 5 and the scanner control device 6, respectively.

To correct the control point before actually performing laser processing, the program generation device 9 generates a control point correction program for correcting the control point. The control point correction program is different in operation from the robot program and scanner program for machining. The control point correction program operates, for example, as follows.

The control point correction program temporarily stops the robot 2 at a position where laser processing of the irradiation shape having a C shape is started in the robot program and scanner program for machining. The control point correction program controls the scanner 4 to irradiate the control point with a guide laser instead of a machining laser.

Next, when the operator performs step feed of the robot 2 (operate to the next posture of the robot 2 and temporarily stop) by operating the robot teaching operation panel 8, the control point correction program moves the robot 2 to a position where the laser processing of the irradiation shape having the C shape is finished, and temporarily stops the robot 2. In this state, the control point correction program controls the scanner 4 to irradiate the control point with the guide laser beam again.

Here, at the laser irradiation start position and the laser irradiation end position, the guide laser beam is emitted to the identical control point on the workpiece 10. However, even if the posture of the robot 2 is changed, since the position in the robot coordinate system is the same, the guide laser beam is emitted to the identical control point regardless of the posture of the robot 2.

When the laser irradiation point on the actual workpiece 10 moves depending on the posture of the robot 2, a deviation occurs between the position of the control point of the control point correction program and the position of the control point on the actual workpiece 10. Thus, the operator can check that the control point has not been set at an appropriate position on the workpiece 10.

Further, when the operator performs step feed of the robot 2 by operating the robot teaching operation panel 8, the control point correction program moves the robot 2 to a position where laser processing of the next irradiation shape is started, and temporarily stops the robot 2. Then, the above-described operations are repeated, and the checking of the setting of the control point is continued.

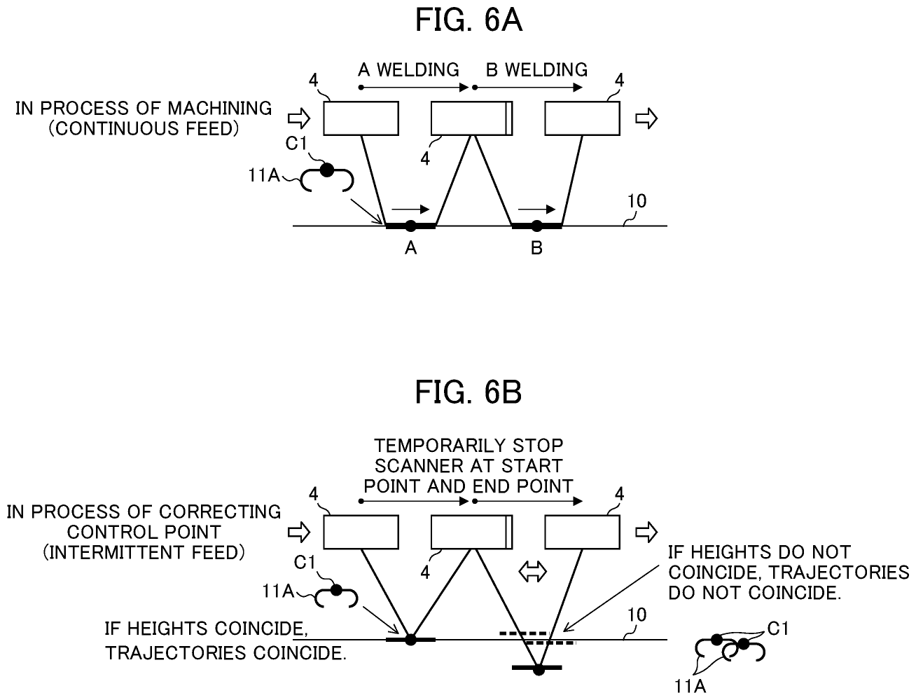

FIGS. 6A and 6B show examples of the operations of the actual laser processing and correcting the control point described above, and are side views of the operations of the scanner 4 when the laser irradiation shape 11A on the workpiece 10 shown in FIG. 5 is machined. FIG. 6A shows the operation of the scanner 4 when laser processing is actually performed.

As shown in FIG. 6A, the robot program and scanner program for machining cause the robot 2 to perform continuous feed of the scanner 4, and control the scanner 4 to apply the laser irradiation shape 11A with the machining laser at positions A and B on the workpiece 10. Thus, the scanner 4 can perform laser welding at the positions A and B.

FIG. 6B shows the operation of the scanner 4 when the control point is corrected. As shown in FIG. 6B, the control point correction program controlled by the irradiation control unit 61 causes the robot 2 to perform intermittent feed of the scanner 4, and stops the movement of the scanner 4 at the laser irradiation start position (start point) and the laser irradiation end position (end point).

Then, the control point correction program controls the scanner 4 to apply the laser irradiation shape 11A with the guide laser beam at the laser irradiation start position and the laser irradiation end position.

Here, if the height of the control point in the optical axis direction in the control point correction program coincides with the height of the control point in the optical axis direction on the actual workpiece 10, the trajectory of the laser irradiation shape 11A at the laser irradiation start position coincides with the trajectory of the laser irradiation shape 11A at the laser irradiation end position.

When the height of the control point in the optical axis direction in the control point correction program does not coincide with the height of the control point in the optical axis direction on the actual workpiece 10, the trajectory of the laser irradiation shape 11A at the laser irradiation start position does not coincide with the trajectory of the laser irradiation shape 11A at the laser irradiation end position.

In such a case, the operator transmits an instruction to move the optical axis direction of the scanner 4 to the scanner control device 6 in a state in which the robot 2 is stopped, by operating the robot teaching operation panel 8, and corrects the control point to a desired position.

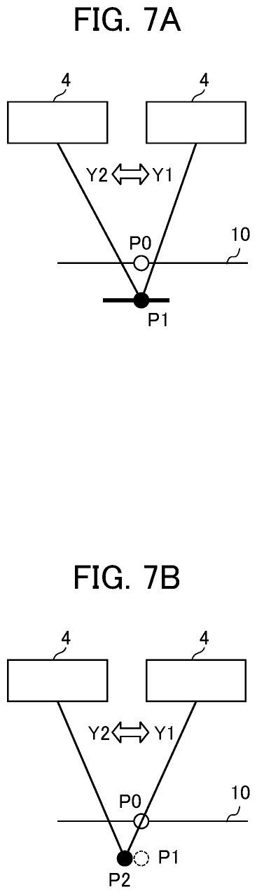

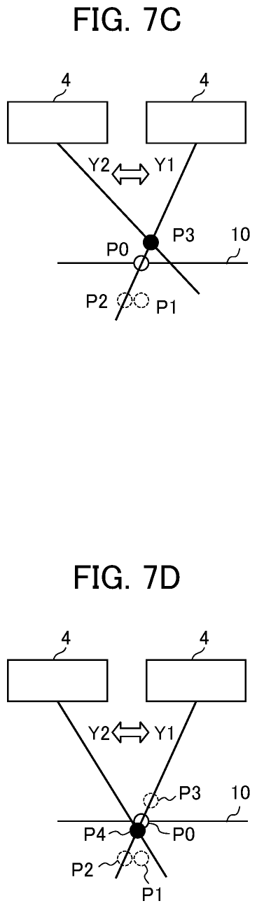

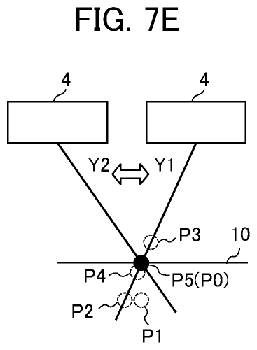

FIG. 7A to 7E show operations of correcting the control point. As shown in FIG. 7A, when the trajectory of the laser irradiation shape 11A at a laser irradiation start position Y1 does not coincide with the trajectory of the laser irradiation shape 11A at a laser irradiation end position Y2, the laser processing system 1 causes the control point moving unit 62 to move a control point P1 at the laser irradiation start position Y1 to an appropriate position on the actual workpiece 10. Then, the scanner control device 6 stores the position of the moved control point and the direction of the moved control point in the coordinate system in the control point storage unit 63 as a control point P0.

Next, as shown in FIG. 7B, when the robot 2 is moved to the laser irradiation end position Y2, since the position of the control point in the optical axis direction remains unchanged, a control point P2 does not coincide with the control point P0.

Next, as shown in FIG. 7C, the robot 2 is moved to the laser irradiation start position Y1, the height of the control point in the optical axis direction at the laser irradiation start position Y1 is changed by the control point moving unit 62, and the control point P2 is moved to the appropriate position (control point P0) on the actual workpiece 10. However, when the position of the control point is moved too much, as shown in FIG. 7C, a control point P3 does not coincide with the control point P0.

Similarly, as shown in FIG. 7D, the robot 2 is moved to the laser irradiation end position Y2, the height of the control point in the optical axis direction at the laser irradiation end position Y2 is changed by the control point moving unit 62, and a control point P4 is moved to the appropriate position (control point P0) on the actual workpiece 10. However, when the position of the control point is moved too much, as shown in FIG. 7D, the control point P4 does not coincide with the control point P0.

In this way, by repeating the processes shown in FIGS. 7A to 7D, a control point P5 finally coincides with the control point P0 as shown in FIG. 7E.

When the correct position of the control point is determined, the scanner control device 6 transmits the position of the control point and the direction of the control point in the coordinate system stored in the control point storage unit 63 to the program generation device 9, and the program generation device 9 corrects the 3D model of the workpiece 10. Thus, the program generation device 9 can generate the robot program and the scanner program reflecting the correct position of the control point.

Here, when the laser irradiation shape for performing laser processing is small, the difference in posture (position) of the robot 2 between the laser irradiation start position and the laser irradiation end position is small. In such a case, the laser processing system 1 may move the robot 2 to any posture without using the postures of the robot 2 at the laser irradiation start position and the laser irradiation end position. Thus, the operator can appropriately correct the control point.

The scanner control device 6 may control the scanner 4 to repeatedly scan the laser irradiation shape at high speed with the guide laser beam. Thereby, the operator can visually recognize the laser irradiation shape including the control point due to the afterimage effect. Therefore, since the scanner 4 emits the guide laser beam from the laser irradiation start position and the laser irradiation end position as in the laser processing, the operator can check, for example, interference between the guide laser beam and an obstacle.

In the embodiment described above, the program generation device 9 uses the scanner program based on the control point and the irradiation shape set in the 3D model. On the other hand, by moving the irradiation point to any point and storing the moved irradiation point without using the control point and the irradiation shape set in the 3D model, the laser processing system 1 can register a new position and coordinates as the control point in manual operations.

For example, the operator places the scanner 4 at a desired position by operating the robot teaching operation panel 8, and sets the irradiation point at any position on the workpiece 10 with the scanner 4 while maintaining the posture of the robot 2.

At this time, actually, it is not known which position on the guide laser beam is the correct irradiation point. Therefore, once any position on the workpiece 10 is stored and the posture of the robot 2 is changed, the scanner 4 emits the guide laser beam again toward the identical irradiation point. When the position of the guide laser beam does not move on the workpiece 10 in these two postures, the laser irradiation point is positioned on the workpiece 10. Then, the laser processing system 1 can register the position and coordinates of the laser irradiation point as the control point.

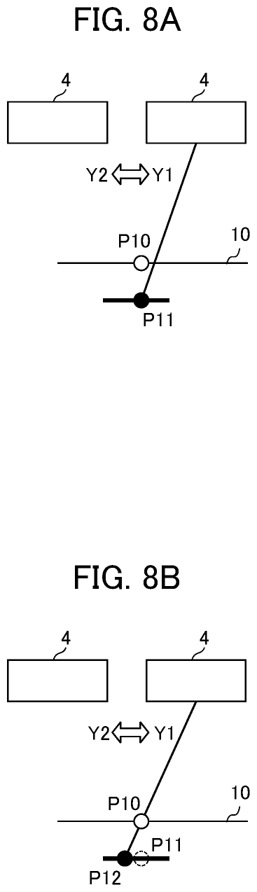

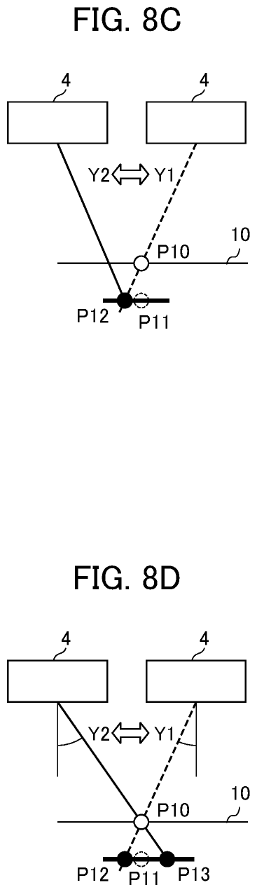

FIGS. 8A to 8D show operations for calculating a corrected control point. As described above, the corrected control point calculation unit 64 calculates the final corrected control point based on a plurality of positions of the control point and a plurality of directions of the control point in the coordinate system stored in the control point storage unit 63.

Specifically, as shown in FIG. 8A, when the irradiation control unit 61 irradiates a control point P11 at the laser irradiation start position Y1 with the guide laser beam, the control point P11 deviates from an appropriate position (final corrected control point P10) on the actual workpiece 10.

Therefore, as shown in FIG. 8B, the operator moves the scanner 4 in the optical axis direction in a state in which the robot 2 is stopped by operating the robot teaching operation panel 8. At this time, since the height in the optical axis direction (that is, the distance between the scanner 4 and the workpiece 10) is not known, the scanner control device 6 stores the position of a control point P12 and the direction of the control point P12 in the coordinate system in the control point storage unit 63 as a corrected control point.

Next, as shown in FIG. 8C, the robot 2 is moved to the laser irradiation end position Y2, and the irradiation control unit 61 irradiates the control point P12 at the laser irradiation end position Y2 with the guide laser beam. The operator moves the scanner 4 in the optical axis direction in a state in which the robot 2 is stopped by operating the robot teaching operation panel 8. The scanner control device 6 stores the position of the control point P12 and the direction of the control point 12 in the coordinate system in the control point storage unit 63 as a corrected control point.

As shown in FIG. 8D, the scanner control device 6 stores the position of a control point P13 and the direction of the control point P13 in the coordinate system in the control point storage unit 63 as a corrected control point.

Based on the control points P12 and P13 obtained in this manner, the laser irradiation start position Y1, and the laser irradiation end position Y2, the corrected control point calculation unit 64 can calculate the height and the position of the final corrected control point P10.

For example, based on the distance between the control point P12 and the control point P13 and the irradiation angles of the scanner 4 at the laser irradiation start position Y1 and the laser irradiation end position Y2, the corrected control point calculation unit 64 can calculate the height and the position of the final corrected control point P10. Thereby, the laser processing system 1 can easily obtain the height and the position of the final corrected control point P10.

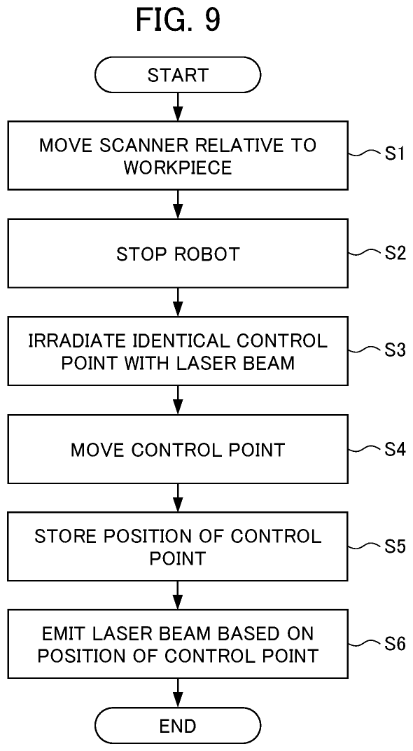

FIG. 9 is a flowchart showing the flow of processing of the laser processing system 1 according to the present embodiment. In Step S1, the robot control device 5 controls the robot 2 based on a robot program so as to move the scanner 4 capable of scanning the workpiece 10 with a laser beam, relative to the workpiece 10.

In Step S2, the robot control device 5 controls the robot 2 based on the robot program so as to stop the scanner 4 at a plurality of positions.

In Step S3, the irradiation control unit 61 controls the scanner 4 to irradiate a preset identical control point on the workpiece 10 with the laser beam in a state in which the scanner 4 is stopped at the plurality of positions by the robot 2.

In Step S4, the control point moving unit 62 moves the control point in response to the operation of the robot teaching operation panel 8 by an operator. In Step S5, the control point storage unit 63 stores a plurality of positions of the moved control point, or the plurality of positions of the control point and a plurality of directions of the control point in a coordinate system.

In Step S6, the irradiation control unit 61 controls the scanner 4 to irradiate the workpiece 10 with the laser beam based on the position of the control point or the plurality of positions of the control point and directions of the control point in the coordinate system.

As described above, the laser processing system 1 according to the present embodiment includes the scanner 4 capable of scanning the workpiece 10 with a laser beam, the robot 2 that moves the scanner 4 relative to the workpiece 10, and the scanner control device 6 that controls the scanner 4. The scanner control device 6 includes the irradiation control unit 61 that controls the scanner 4 to irradiate a preset identical control point on the workpiece 10 with the laser beam in a state in which the scanner 4 is stopped at a plurality of positions by the robot 2. Thus, the laser processing system 1 can easily correct the control point.

The plurality of positions include a laser irradiation start position and a laser irradiation end position of the scanner 4 corresponding to a laser irradiation start point and a laser irradiation end point of a scanner program for controlling the scanner 4 and a robot program for controlling the robot 2. Thus, the laser processing system 1 can correct the control point using the laser irradiation start position and the laser irradiation end position of the scanner 4.

The scanner control device 6 further includes the control point moving unit 62 that moves the control point, and the control point storage unit 63 that stores the position of the moved control point, or the position of the moved control point and the direction defined by the moved control point in a coordinate system. The irradiation control unit 61 controls the scanner 4 to irradiate the workpiece 10 with a laser beam based on the position of the moved control point, or the position of the moved control point and the direction defined by the moved control point in the coordinate system. Thereby, the laser processing system 1 can appropriately correct the control point.

The scanner control device 6 further includes the control point moving unit 62 that moves the control point, the control point storage unit 63 that stores a plurality of positions of the moved control point, or the plurality of positions of the moved control point and a plurality of directions defined by the moved control point in the coordinate system, and a corrected control point calculation unit 64 that calculates a corrected control point that is a finally corrected control point based on the plurality of positions of the moved control point, or the plurality of positions of the moved control point and the plurality of directions defined by the moved control point in the coordinate system. Thereby, the laser processing system 1 can obtain the final corrected control point by calculation.

The embodiments of the present invention have been described above, but the laser processing system 1 can be implemented by hardware, software, or a combination thereof. The control method performed by the laser processing system 1 can also be implemented by hardware, software, or a combination thereof. Here, “implemented by software” means that it is implemented by a computer reading and executing a program.

The program may be stored in various types of non-transitory computer readable media to be provided to the computer. The non-transitory computer readable media include various types of tangible storage media. Examples of the non-transitory computer readable media include magnetic recording media (e.g., hard disk drives), magneto-optical recording media (e.g., magneto-optical disks), CD-ROMs (read only memories), CD-Rs, CD-R/Ws, and semiconductor memories (e.g., mask ROMs, PROMs (programmable ROMs), EPROMs (erasable PROMs), flash ROMs, and RAMs (random access memories)).

Although the above-described embodiments are preferred embodiments of the present invention, the scope of the present invention is not limited to the above-described embodiments. Various modifications can be made without departing from the gist of the present invention.

### EXPLANATION OF REFERENCE NUMERALS

1 laser processing system
2 robot
3 laser oscillator
4 scanner
5 robot control device
6 scanner control device
7 laser control device
8 robot teaching operation panel
9 program generation device
10 workpiece
61 irradiation control unit
62 control point moving unit
63 control point storage unit
64 corrected control point calculation unit

1. A laser processing system, comprising:
a scanner capable of scanning a workpiece with a laser beam;
a moving device configured to move the scanner relative to the workpiece; and
a scanner control device configured to control the scanner,
wherein the scanner control device comprises an irradiation control unit configured to control the scanner to irradiate a preset identical control point on the workpiece with the laser beam in a state in which the scanner is stopped at a plurality of positions by the moving device.

2. The laser processing system according to claim 1,
wherein the plurality of positions include a laser irradiation start position and a laser irradiation end position of the scanner corresponding to a laser irradiation start point and a laser irradiation end point of program for controlling the scanner and the moving device.

3. The laser processing system according to claim 1,
wherein the scanner control device further comprises:
a control point moving unit configured to move the control point; and
a control point storage unit configured to store a position of the moved control point, or the position of the moved control point and a direction defined by the moved control point in a coordinate system, and
wherein the irradiation control unit controls the scanner to irradiate the workpiece with the laser beam based on the position of the moved control point, or the position of the moved control point and the direction defined by the moved control point in the coordinate system.

4. The laser processing system according to claim 1,
wherein the scanner control device further comprises:
a control point moving unit configured to move the control point;
a control point storage unit configured to store a plurality of positions of the moved control point, or the plurality of positions of the moved control point and a plurality of directions defined by the moved control point in a coordinate system; and
a corrected control point calculation unit configured to calculate a corrected control point that is a finally corrected control point based on the plurality of positions of the moved control point, or the plurality of positions of the moved control point and the plurality of directions defined by the moved control point in the coordinate system.

5. A method for controlling a laser processing system, the method comprising:
moving a scanner capable of scanning a workpiece with a laser beam, relative to the workpiece;
stopping a moving device for moving the scanner relative to the workpiece at a plurality of positions; and
controlling the scanner to irradiate a preset identical control point on the workpiece with the laser beam in a state in which the scanner is stopped at the plurality of positions by the moving device.
